(19) United States
(12) Patent Application Publication
(10) Pub. No.: US 2010/0269881 A1
(43) Pub. Date: Oct. 28, 2010

(54) AREA-MEASURED MATERIAL

(75) Inventor: George SCHELLER, Bad Godesberg (DE)

Correspondence Address: CANTOR COLBURN, LLP, 20 Church Street, 22nd Floor, Hartford, CT, 06103, US

(73) Assignee: Gudrun Charlotte Scheller, Bad Godesberg (DE)

(21) Appl. No.: 12/765,306

(22) Filed: Apr. 22, 2010

(30) Foreign Application Priority Data
Apr. 22, 2009 (DE) 10 2009 018 196.2

(51) Int. Cl. B32B 5/02; D04C 1/00; D03D 9/00; D04B 1/00; D04H 13/00; B32B 5/00

(52) U.S. Cl. 136/242; 428/221; 442/1; 442/304; 442/327; 428/332

(57) ABSTRACT

The present invention concerns an area-measured material (sheet material) (10) comprising a continuous surface portion (frames) and a void content (12) of at least 25%, preferably 50% or more in relation to the total area covered by the area-measured material (sheet material). The continuous surface portion frames consists totally or partially of hollow structures, tubes or capillaries (13) tailored to transport a fluid medium. These hollow structures are docked to at least one collector (11). Both textile sheet material with hollow fibres, sheets, films, panels or composite structures of sheets, films or panels with hollow structures as tubes or capillaries can be used as well as grids with elongated ribbon-like elements. These area-measured materials (sheet materials) can be used for instance to absorb and/or store and/or transport and/or to discharge energy, in particular, if the “energy density” is low. The absorbed energy can be converted into any other kind of energy.

### CROSS REFERENCE TO RELATED APPLICATION

This application claims priority to German Patent Application No. 10 2009 018 196.2, which is fully incorporated herein by reference.

### TECHNICAL FIELD

The present invention refers to an area-measured material (sheet material) as a textile (woven fabric, knitted fabric, netting, non-woven fabric), or as a film compound/sheet com-pound arrangement or as a grid or mesh consisting totally or partly of hollow structures as in tubes or capillaries.

### BACKGROUND

According to the state of the art, textiles consisting of such hollow fibres are known. Usually such hollow fibres are manufactured by extrusion and are used to increase thermal isolation or are used to reduce material input. Another application is specifically described in patent FR 2 428 224 A. In this application hollow fibres are used to transport fluids. This type of textile however consists of a surface with no perforations.

Known and as such state of the art are grids or mesh made from hollow fibres out of metal. In patent DE 199 10 985 A1 grids or mesh made of metal tubing or capillaries are described whereby a grid or mesh from a synthetic material is manufactured. This is then coated over with a metal film. The synthetic core is then incinerated resulting in metal tubes.

These textiles have a high fibre density and the voids between the fibres and filaments are less than 1 mm. These types of textiles are not sheets with perforations or with voids as in the sense of the present invention but describe sheets without any perforations or voids as such.

Patent WO 2007/131475 A1 describes a heat exchanger consisting of a woven structure, wherein warp and weft threads partially consist of tubes and capillaries which are embedded into the woven structure consisting of wire filaments. The structure described regards a tight and compact sheet without perforations whatever, as is described in the present invention.

Well known and thereby state of the art are so called “nanotubes” made from carbon fibres as described for instance, in the European patent EP 1 529 857 A1. From such carbon fibre “nanotubes” woven and non-woven fabrics can be produced. Hereby however, specific characteristics of such carbon fibres are used, such as their electric conductivity, thermal conductivity and their high mechanical strength so as to manufacture protective clothing as an example. The “nanotubes” used have a diameter of only 1-10 nanometers. These are spun so that the result is a very tight textile comprising of millions of fibres. The manufacture of sheet material with perforations according to the present invention is not described in this paper. Moreover, the cross-sections of such nanotubes are not suitable for transporting a sufficient quantity of fluid medium as described by the present invention.

Nor are so-called “mesotubes” with an internal diameter of less than 0.1 mm (for most parts only up to 50 nm) as are described in WO 01/09414 A1 suitable for the storage or for the transport of a fluid medium as described by the present invention.

Perforated sheeting as a textile as in lace is known. Perforated textiles with bundled fibre groups both as warp and weft threads, are described in patent EP 0 950 737 A 1, each having voids in between, so that a kind of grid or mesh is formed. Such perforated textiles or textiles with a relatively high void content employ no hollow fibres.

Patent DE 28 56 642 C2 describes a heat exchanger comprising of hose-pipes with thin walls which are made from polymers by way of a melting/spinning process. These thin-walled hose pipes are wound one over the other in several layers on a spool holder, so that a coil comprising of several layers of thin-walled hose pipes is formed. To effectively achieve their goal (a rapid energy exchange and an effective transfer of high energy densities) the hose-pipes are placed as close to each other as possible to form a very compact arrangement which cannot be compared to a perforated sheet textile, film or grid.

The object of the present invention consists in defining an area-measured material (sheet material) of the type mentioned above wherein the surface portion comprising the hollow structures (tubes or capillaries) defining the active part of the structure for a transfer of energy, represents only a fraction of the total surface area of the sheet material. Said sheet material therefore can be made at relatively low costs and thus is economically viable for implementation over large expanses.

### SUMMARY

This object is achieved by an area-measured material (sheet material) with the features of the main claim.

According to the present invention, the sheet material comprises a continuous surface portion (frames) (without any perforations or voids) and a void content of at least 25%, preferably 50% or more, in relation to the total area covered by the sheet material whereby the continuous surface portion (frames) comprises incorporated hollow structures (tubes or capillaries) adapted to transport a fluid medium, wherein these hollow structures are docked to at least one fluid collector.

The area-measured material (sheet material)) as understood in this invention can be a textile or a film or a panel or a composite sheet material or panels/frames or an area-measured structure comprising of hollow or solid elongated grid elements forming ribbons joined together by pins.

Is the sheet material of the present invention a textile, the sheet material comes then in form of an openwork fabric, lace, knit, braid, net or mesh, wherein the hollow structures are comprised of hollow fibres, tubes or capillaries. A percentage of the threads or fibres can consist of hollow fibres, tubes or capillaries, to an extent of 50% in volume of the threads or fibres, preferably to the extent of 100% in volume. This results in two parameters that may be varied within the sheet material on one hand the percentage of perforations in relation to the total surface and on the other hand the percentage of hollow fibres, tubes or capillaries in the textile which can be varied from high to low. Hereby the “active” portion of the sheet material which contains the fluid medium can be extensively varied depending on need.

“Fluids” according to the present invention are liquids or gases or fluid-like solids, e.g. fine flowable particles or mixtures thereof.

According to a second possible alternative of the present invention the sheet material can be a film, sheet or panel or a composite of films, sheets or panels implementing hollow structures. These sheet materials can be manufactured for instance by making a first sheet layer comprising of one half of the hollow structures and overlaying it with a second complementary sheet layer facing the first one and complementing the other half of the hollow structures, and permanently joining the two by heat-sealing. The perforations are created by removing specific areas between the hollow structures by means of suitable processes, such as mechanical, hydraulic, chemical, optical or other techniques. Wherever in the present patent application the term “film” or “sheet” is used, sheets with a greater material thickness, e.g. more than 1 mm are then called plates. The application therefore in no way restricted to sheets of minor thickness according to the conventional definition, but includes area-measured materials in form of plates or composite plates comprising of said hollow structures. Area-measured materials in form of films, sheets or plates have the advantage of a simple manufacturing process, especially in view of docking the collectors and the hollow structures, for which there is no specific production step required during the manufacturing process.

According to a third possible alternative of the invention the area-measured material (sheet material) is a structure of hollow and solid (massive) elongated grid elements comprising of ribbons which are interconnected by means of pins. In this embodiment the connections between the hollow structures (tubes and capillaries) and the collectors can be plug connectors. Moreover this alternative allows to also the grid to dock elements which cross each other and are usually oriented in longitudinal and transversal directions by plug connectors. For instance female elements on one grid element and corresponding male elements on the other grid element can be used. These can be e.g. projections in the form of cones which are plugged into receptacles that have an undercut so that a kind of click-stop arrangement is provided. This alternative is especially chosen if the hollow ribbons have larger dimensions, since the flat-shaped material is mounted by plug connection between said hollow ribbons. In contrast thereto the alternatives to “textile” and “sheet” the sheet material here is obtained in its whole with hollow structures including perforations at the end of the manufacturing process.

According to the present invention, the dimensions of the hollow fibres, tubes, capillaries or hollow structures have been preferably chosen so that the hollow fibres or hollow structures have an average inner diameter of at least about 1 mm, whereby the hollow fibres or hollow structures have preferably wall thicknesses of at least about 0.1 mm. These dimensions en-sure on one hand a sufficient flow of the fluid medium through the hollow fibres or the hollow structures according to the invention. On the other hand the hollow fibres or the hollow structures have sufficient stability so that the sheet material can be manufactured easily and cost-efficiently by suitable industrial techniques. Furthermore, the average internal diameter of the hollow structures can preferably amount to at least 2 mm. The corresponding wall thick-nesses may be varied so that the outer diameters vary accordingly. The individual values of the outer diameter of the hollow fibres/hollow structures are not critical for the invention.

Particular suitable dimensions of the hollow fibres, tubes, capillaries or hollow structures are in the range of average inner diameters in the order of about 1 mm and more. The outer diameters and the distances of the hollow fibres or hollow structures between each other for both dimensions (transversal and longitudinal direction) define the size and the percentage of perforated surface. The distance between two adjacent hollow fibres or hollow structures is preferably at least in the order of about twice the outer diameter of the hollow fibres or hollow structures, more preferably, a distance in the range between 2 and 10 times the outer diameter. Generally the perforations of the sheet material are dimensioned so that they are visible to the naked eye.

Since the inner diameter of the hollow fibres should be preferably at least about 1 mm and the wall thickness of the hollow fibres should be preferably be at least about 0.1 mm the result for the outer diameter is at least about 1.2 mm. The voids resulting from the perforations have dimensions, as stated, which are a multiple of the outer diameter of a single hollow fibre. The dimensions of these voids (perforations) should therefore be at least about 7 mm in both directions (longitudinal and transversal), so that the rectangular perforations in each case results in voids of a size in the range of about 50 mm². The perforations can, however, also be of a considerably greater size, as well as the percentage of voids (perforations) related to the total surface can be considerably higher than 25%. It can easily be more than 50% or even more than 70%. In this context, reference is made to the embodiments and to the schematic drawings according to FIG. 7 a to FIG. 7c.

The individual hollow fibre, tube, capillary or hollow structure can have a single lumen or be comprised of several lumina. This means that for instance one fibre can include several lumina, through which the fluid medium is transported. The lumen of the hollow fibre or the hollow structure and/or its external shape can vary over its length (e.g. transition from a round to a flat cross-section).

In the case of textile sheet material the hollow fibres mainly occur as mono-filament which enables more basic manufacturing processes.

According to one embodiment of the invention, the hollow fibres, tubes, capillaries or hollow structures used for the sheet material can be elastic (for by tensile stress in longitudinal direction) and/or ductile (at by radial stress of the hollow space under pressure) so that for in-stance inflatable hollow structures can be provided.

The hollow fibres, tubes, capillaries or hollow structures used for the sheet material according to the present invention can be of any nature and may consist of any material and may have any form or shape. Since the inner shape of the fibres existing as mono-filament can be very different from the outside, e.g. oval, ellipsoid, flat oval, ribbon-like, the outer diameter of the mono-filament varies over the periphery. Depending on the orientation of the mono-filaments within the sheet material, the percentage of the perforations (voids) can vary too. In the present patent application the average outer diameter of the hollow fibres shall be taken in each case to calculate the portion of the perforations (voids) in relation to the total area. In a sheet material the percentage of the perforations (voids) results from the difference between the total area covered by the sheet material and the covered surface portion. If one imagines a vertical projection of the sheet material the continuous surface portion produces a shadow and the perforations produce blanks (empty spaces). In order to avoid discrepancies as the outer diameter of the hollow fibres in the sheet material varies over their periphery, depending on the position of the hollow fibre in the flat-shaped material, an (theoretical) average outer diameter is used as the definition of the percentage of perforations (voids) obtained.

For a sheet material according to the present invention there are various application possibilities. Preferably the fluid medium transported in the hollow structures should be suitable for absorbing and/or storing and/or transporting and/or emitting energy. For instance the sheet material can be suitable for absorbing energy in the form of any kind of electro-magnetic radiation. This energy can then be stored in the fluid medium, available in the hollow structures, tubes or capillaries it can be transported via the fluid medium in the hollow structures which can then be reemitted.

In this case one possible embodiment of the invention provides the energy of one energy form or of an energy state is then converted into energy of another energy form or of another energy state via a suitable transformer that is either part of the sheet material or is connected to the said sheet material. Energy forms in the sense of the invention can be mechanical energy, thermal energy, radioactive energy, electrical energy, chemical energy and nuclear energy. Each type of energy can principally be converted into one of the other energy forms. For example energy in the form of electromagnetic waves can be converted into electric power, light or thermal energy, or chemical energy into thermal energy, or mechanical energy into electric power.

Just to give a possible concrete example: sheet material according to the invention can be used in the sea as a type of wave power plant, wherein the sheet material in water is forced moved by mechanical energy, thereby generating flow of the fluid medium contained in the hollow structures. This in turn causes fluid to flow into the collector which through valves and/or turbine-type components is used to generate electrical energy.

Another similar example would to be to use sheet material in the air to obtain wind energy.

Another realistic example for use for sheet material is in the field of “energy harvesting” whereby energy is generated in areas where only small e.g. temperature differences occur between the fluid medium and the environment, for the production of geothermal energy. In order to harvest a sufficient quantity of “low-density energy”, preferably large surfaces have to be employed for energy an exchange. In such cases the sheet material according to the invention can be favourably used as it can be manufactured cost-effectively for expansive surfaces and whereby the “active” exchange surface in relation to the total surface of the sheet material can be strongly varied by way of the two parameters the “Percentage of perforations (voids)” and “Percentage of hollow structures”. The portion of the active surface can hereby be essentially smaller than the total surface area of the sheet which allows tailoring the portion of the active surface so that the available low-density energy in the soil can be collected at an optimum efficiency whereby only so much material is used as really necessary.

A further advantage of the area-measured material (sheet material) with voids is seen in the fact that it is robust, for that excess energy which is not absorbed by the system does not put undue stress on the sheet material. If for instance the sheet material is employed for generating energy from windpower, the too strong wind flows through the perforations (voids), thus easing the pressure on the sheet material.

Other possible applications of the sheet material according to the invention are to be seen specifically within surface heating such as in heating floors, ceilings and walls, whereby for example the sheet material can be embedded in a cast as concrete or the like.

Perforated sheet material can serve as convectors, heat exchangers as well as cooling elements.

Two or more sheet materials, according to the invention, with different functions can be combined with each other; for instance, the first one as heater and the second as a cooling element.

A possible usage arises when the sheet material is suitable to absorb electromagnetic radiation, particularly in the form of light, whereby this energy for instance can be stored in the form of chemical energy or thermal energy, and or especially can then be converted into electrical energy. Light energy can in this case be absorbed via NIRF, anti-Stokes lines, UV-absorbing pigments, luciferins or the like.

Energy can also be absorbed via other electromagnetic radiation or other energy forms and be discharged in the form of light and by way of radio luminescence, cathode luminescence, triboluminescence, electroluminescence and thermoluminescence.

The hollow fibres, tubes, capillaries or hollow structures of the sheet material are respectively docked with at least one collector particularly of a hollow structure with a larger clear cross-section, as for example a tube. Larger cross-sections do not mean that the cross-section of the collector is generally greater than the lumen of a single hollow fibre, so that the fluid medium from the hollow fibres can be collected in the collector and can be so transported. The collector does not, however, have to be a tube-form or hose-type hollow structure but is in principle any hollow structure or any receptacle. The collector could for instance even be a sheet material of the above kind itself.

The sheet material according to the present invention, with hollow fibres/hollow structures is adapted to distribute matter by means of the fluid medium over expansive areas. The hollow fibres/hollow structures are filled with fluid medium (matter) which can flow into said hollow structures. Thereby, energy can be cost-effectively collected, stored, transported and radiated again in another surface area. The perforated sheet material can thus be absorber, storage, distributor and convector for energy all at the same time. Since the sheet material is perforated (see voids), the use of material can be kept low and tailored to the requirement. Thus, larger surfaces can be cost-effectively, resp. economically covered. In doing so, the harvesting of energy becomes economic when dealing with low energy densities.

The sheet material according to the invention is specifically suited for and favours the cover-age of extended surfaces because it can be produced economically and with an outlay that is technically justifiable. Extended large surfaces are understood in the sense of the present invention as surfaces of for instance 5 m²-10 m² and more. Surfaces of 1000 m² and more are conceivable.

The sheet material can for instance be used for the passive energy generation via piezomembranes, whereby the extraction behaviour of the matter in the hollow space caused by natural forces (environmental parameters) as thermal energy, waves, wind etc. is used. Thus energy can be absorbed and converted.

Or the sheet material can be used for “active” energy generation, whereby the sheet material is moved in total through other matter (fluttering in the water or in the air) and the kinetic energy is transferred by an energy converter and is so used.

The features stated in the sub-claims describe preferred embodiments of the present invention. Further benefits of the invention ensue from the following detailed description.

### BRIEF DESCRIPTION OF THE DRAWINGS

Hereafter examples and preferred embodiments of the present invention are described in more detail referring to the attached drawings, wherein:

FIG. 1 is a schematic simplified plan view of a section of a sheet material according to a first embodiment of the invention;

FIG. 1a is a schematic simplified perspective view of a sheet material according to an alternative embodiment of the invention;

FIG. 2 is a sectional view through the sheet material along the line II-II of FIG. 1;

FIG. 3 is a sectional view through the sheet material along the line III-III of FIG. 1;

FIG. 4a shows two examples of sectional views through hollow fibres of a sheet material according to the present invention;

FIG. 4b shows two more examples of sectional views through hollow fibres for a sheet material according to the present invention;

FIG. 4c shows one more example of a sectional view through a hollow fibre for a sheet material according to the present invention;

FIG. 4d shows a schematic perspective view of a hollow fibre for a sheet material according to a possible alternative of the present invention;

FIG. 5 is a schematic simplified plan view of a section of an area-measured material ac-cording to a possible example of an alternative of the present invention;

FIG. 5a is a schematic simplified view of an area-measured material according to an alter-native of the present invention;

FIG. 6 shows a schematic perspective view of a section of an area-measured material according to a further alternative of the present invention;

FIG. 7a is a schematic view of an example of an alternative sheet material with a percentage of perforations;

FIG. 7b is a schematic view of a further example of an alternative sheet material according to the present invention with a greater percentage of perforations (voids);

FIG. 7c is a schematic view of a further example of an alternative sheet material according to the present invention with a still greater percentage of perforations.

### DETAILED DESCRIPTION

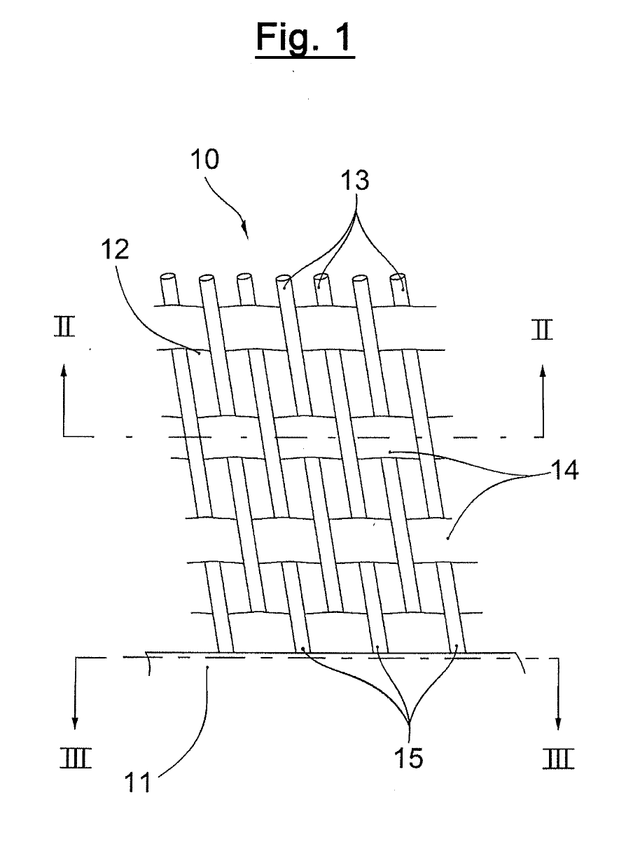

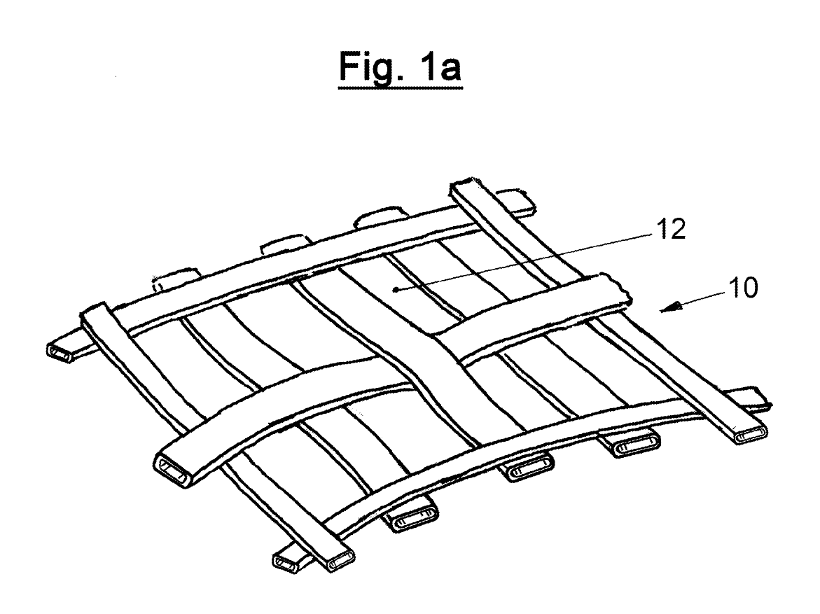

First reference is made to FIG. 1. The drawing shows a schematically simplified view of a section of a sheet material according to the present invention that is denominated in its whole with the reference number 10. The schematic view shall only explain the essentials of the invention, therefore the shown details do not reflect the correct scale. As it can be seen, the sheet material spans over a total surface area which has a surface portion for instance in the form of a textile (fabric) and furthermore has perforations (voids) 12 where there is no textile. These perforations 12 represent a percentage of more than 25% related to the total surface area. The percentage of perforations 12 can also be essentially greater than shown in the drawing, for instance essentially more than half of the total surface area can consist of perforations 12.

The textile part of the sheet material 10 consists of numerous hollow fibres 13, that can run in the same direction, for instance in warp direction and of ordinary solid fibres 14, that can also run in one direction of the textile, for instance transversally to the hollow fibres 13 as in the weft direction. The textile can however be designed in a more complex manner or consist only of hollow fibres. It can as well be a grid or a mesh. The drawing only shows one of many possible embodiments.

The fibres 14 are relatively large and flat at this alternative, i.e. rather ribbon-like instead of having a circular cross-section.

Alternatively, the sheet material 10 can have for instance, fibres 14 (threads) in warp direction whilst the weft threads are designed as hollow fibres. Again, according to further possible alternatives both the warp and the weft threads can be executed as hollow fibres 13 or there are hollow fibres 13 and threads 14 in the warp direction, and also hollow fibres 13 and threads 14 in the weft direction.

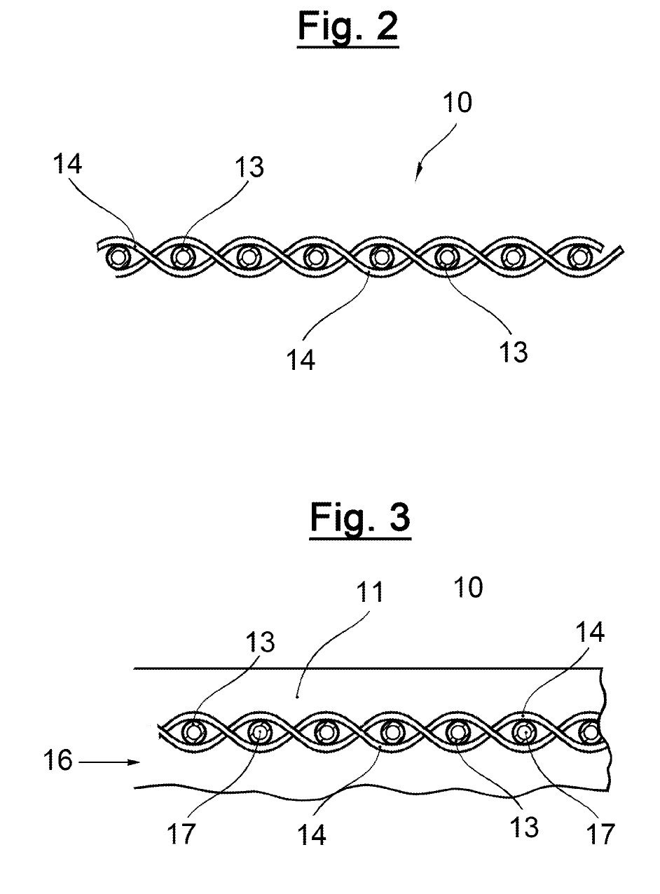

The drawings according to FIGS. 2 and 3 show each one schematically simplified and enlarged cross-section views. In FIG. 2 the hollow fibres 13 can be seen and in transversal direction the ordinary fibres 14. The scales have been chosen arbitrarily. The ordinary fibres 14 can also be considerably bigger in relation to the hollow fibres 13, the wall thickness of the hollow fibres can also be bigger or smaller, as well as the structure of the textile can be completely different. This is of no matter for the present invention.

FIG. 3 shows that the hollow fibres 13 have one lumen each, through which a fluid medium is transported. As can be seen from FIG. 1, the hollow fibres 14 are connected with their ends 15 at least on one side to a collector 11, whereby the lumen 17 of the hollow fibres 14 have a fluid connection with the inner space 16 of the collector (see FIG. 3). Hereby the fluid medium which is transported in the hollow fibres 13 can flow into the internal volume 16 of the collector 11 and in the collector 11 which for instance is a pipe or tube with a bigger cross-section as the hollow fibre can continue to flow, for instance to equipment not shown here, for trans-forming the energy which is stored within the fluid medium. The collector can also be any type and form of other container or receptacle and therefore is only schematically shown in FIG. 3 since the exact form of collector 11 is of no importance.

FIG. 1a shows a possible alternative embodiment, wherein the sheet material consists of flat ribbon-like or tape-like hollow structures which are interwoven so that some kind of grid or mesh results. The fluid medium can flow through the cavities in the ribbon-like hollow structures. The perforations (voids) are formed by distances existing between the ribbon-like hollow structures. The hollow structures of the grid or mesh extend in longitudinal and in transversal direction. The collector is not shown here.

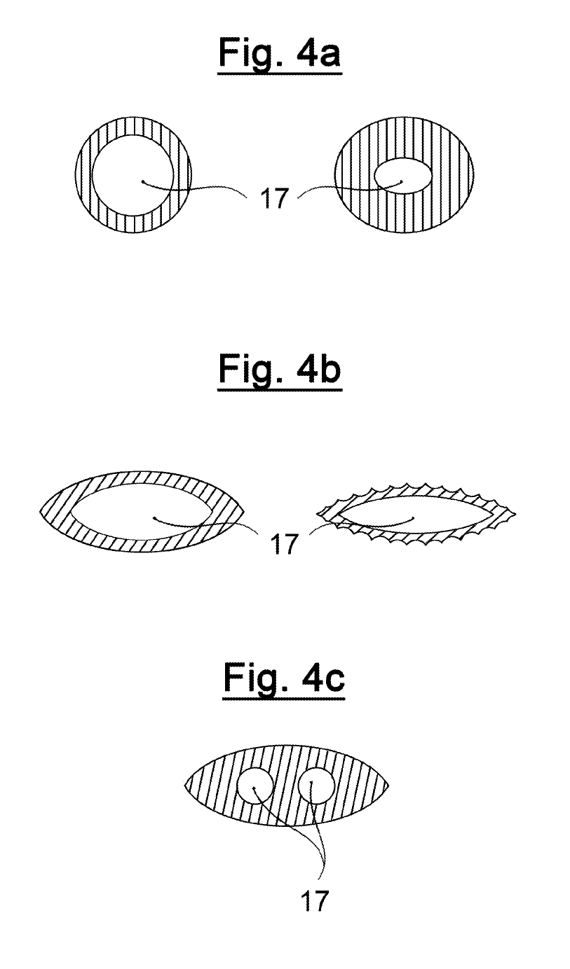

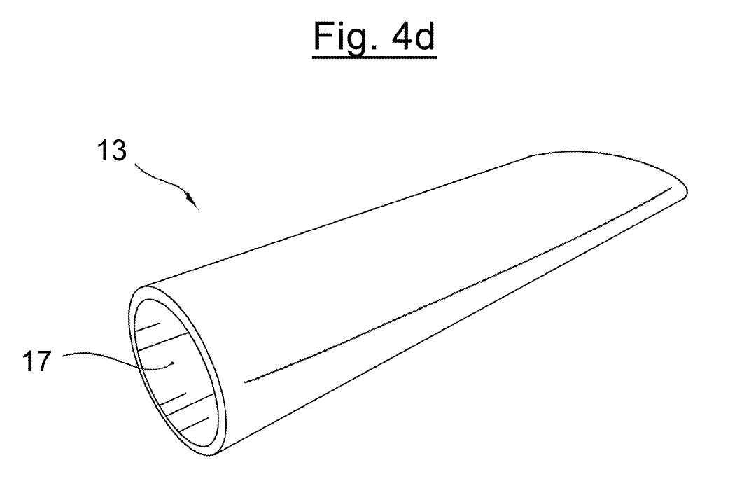

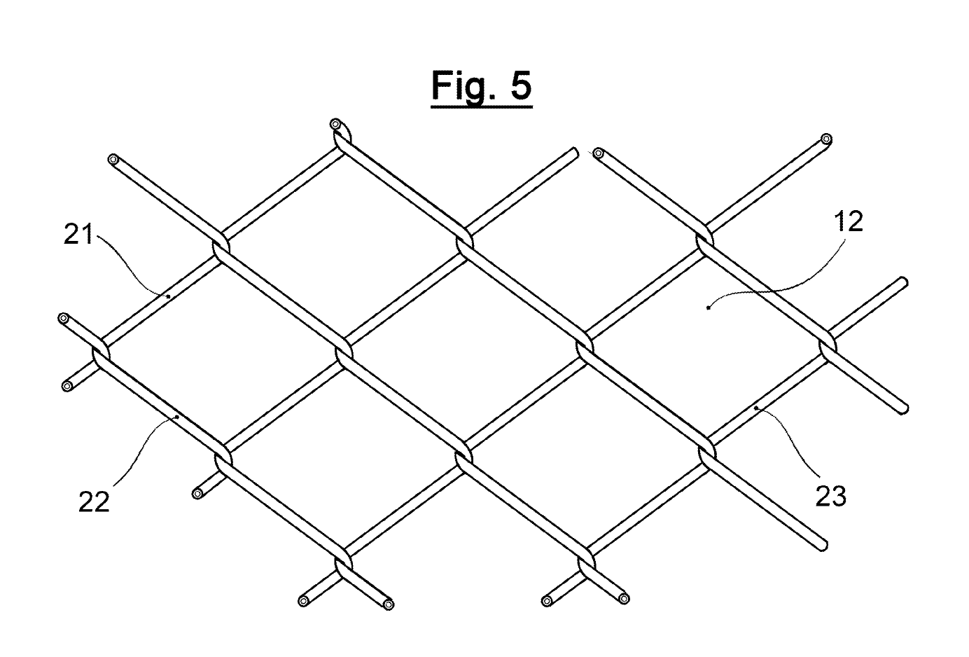

FIGS. 4a, 4b and 4c show by way of example, possible cross-sections of hollow fibres 13 with different lumina 17. The hollow fibres as to FIG. 4a each are round or oval in their profile (contour). With the first alternative the lumen 17 is big and the wall thickness smaller, whereas with the second alternative (Fig. on the right side) the profile is oval, the lumen 17 is smaller, and therefore the wall thickness of the hollow fibre is bigger accordingly.

The two hollow fibres 13 shown in FIG. 4b have more the form of ribbons or tapes which are more or less flat whereby the lumen 17 for the flowing fluid medium can change approximately with the profile of the hollow fibre, and can be oval or flat oval as shown in the two presentations of FIG. 4b Hereby the shape of the lumen is independent of the actual form of the outer profile. The example shall illustrate that flat and ribbon-like hollow fibres can be considered as well. With the alternative according to the picture on the right side of FIG. 4b the outer surface of the hollow fibre has a profile whereas the outer surface of the hollow fibre on the left picture of FIG. 4b is smooth.

FIG. 4c shows another example shows an alternative of a hollow fibre 13, which has no circular outer contour but is flat and rather resembles a ribbon or tape. The drawing is to make clear that a hollow fibre according to the present invention can have for instance two lumina 17 independent from each other through which the fluid medium flows.

FIG. 4d shows a specific alternative of a hollow fibre 13 where the lumen 17 of the hollow fibre changes over its length. At one end (on the left side in the drawing) it has for instance nearly a cylindrical hollow section whereas the hollow fibre becomes gradually flatter and gets more the shape of a ribbon or tape at the other side. The outer profile and lumen 17 of the hollow fibre 13 can for instance change continuously over the length.

FIG. 5 shows a part of an area-measured material or according to a further alternative of the present invention where the area-measured material is a grid or mesh which can be com-pared with a wire mesh whereby this mesh can consist partly of hollow fibres 21, 22, 23 or hollow wires and partly of massive solid fibres or wires. When using fibres/hollow fibres, these elements have at least partly a certain inherent stability which stabilizes the mesh. As can be seen from FIG. 5, the perforations (voids) in this alternative constitute a bigger portion related to the total surface area of the area-measured material as compared to other alternatives described before.

FIG. 5a shows a part of an area-measured material 10 according to a further alternative of the present invention. Here the material is a textile of hollow fibres 21, 22, 23. There can be also hollow fibres 21 and ordinary fibres combined together in such a texture. The hollow fibres and solid fibres are linked by knitting to form a textile sheet material. Furthermore, the sheet material 10 shows perforations 12. Sheet material with mesh structure for instance, can also be manufactured from metal (wire).

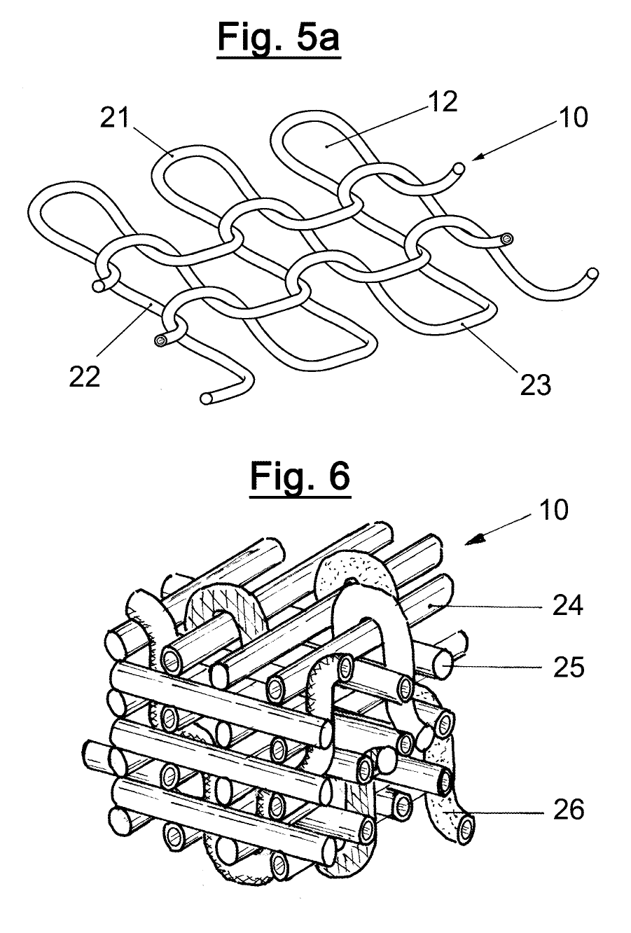

FIG. 6 shows a part of a sheet material 10 according to a further alternative of the invention. In this example there is a 3D-tissue from hollow fibres 24, 25, 26 and ordinary fibres should the occasion arise. In this example the hollow fibres, tubes or capillaries 24 or fibres of a first group run in longitudinal direction, the hollow fibres, tubes or capillaries of group 25 of a second group in transversal direction and hollow fibres, tubes, capillaries or fibres 26 of a third group run in vertical direction to the plain of the (hollow) fibres of the (hollow) fibres of the first and second group, whereby the (hollow) fibres of the third group form meshes and the (hollow) fibres of the first and second group are herewith interconnected to 3D-textile or fabric. This is an area-measured structure as in the other embodiments. In the drawings only a small section of the area-measured structure has been shown for demonstration purpose, so that the perforations (voids) cannot be seen. The collector has not been shown in the examples of the FIGS. 5, 5a and 6.

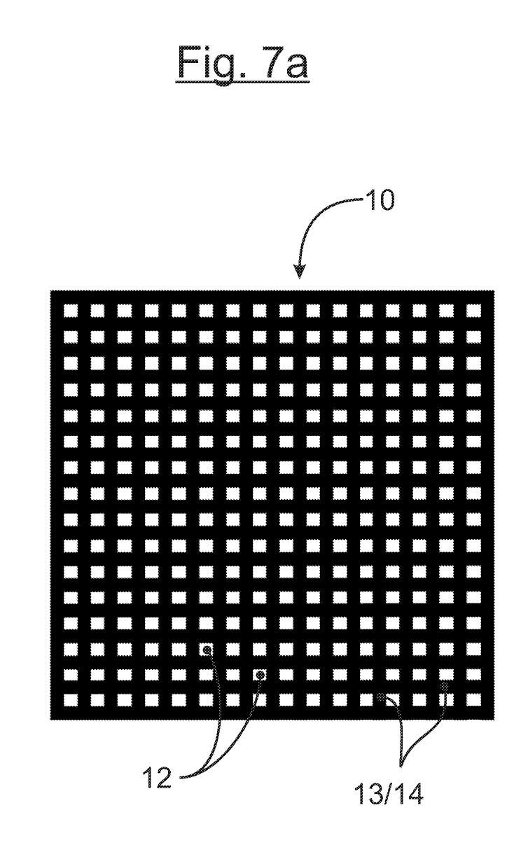

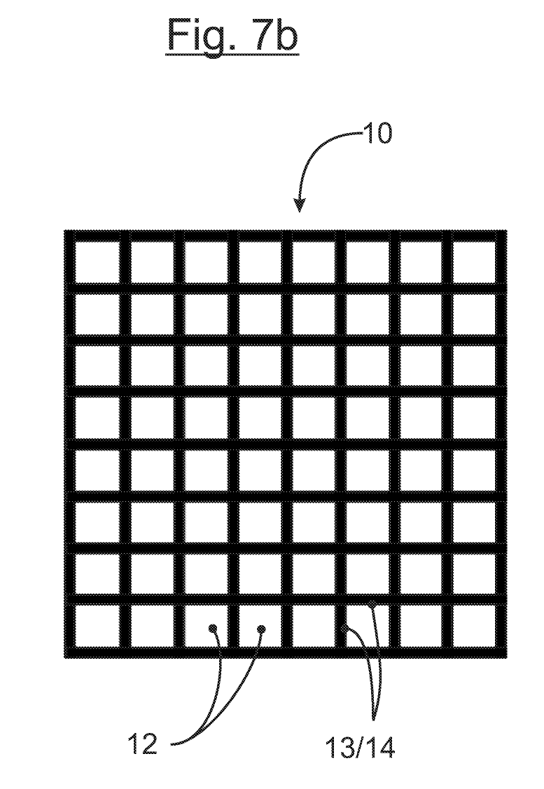

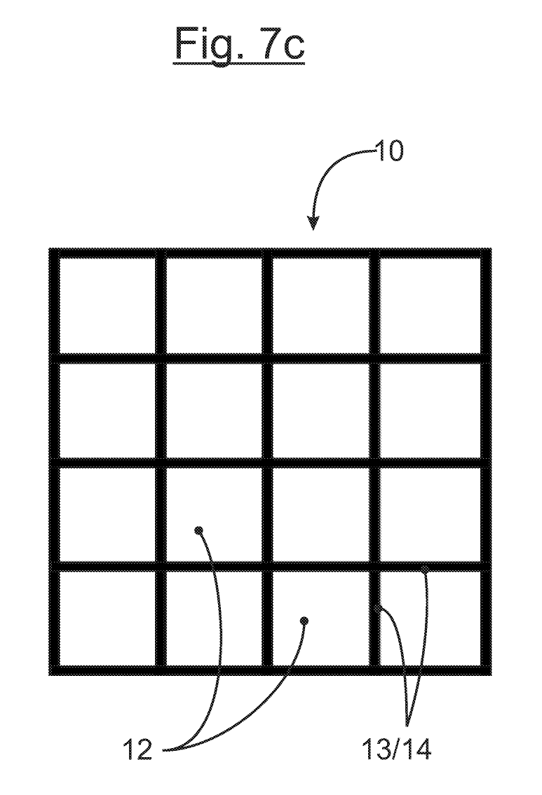

FIGS. 7a, 7b and 7c are schematic views of various examples of alternatives of an area-measured material (sheet material) 10 according to the present invention which demonstrates the effect of varying the percentage of perforations (voids) 12 related to the spread total surface area of the sheet material 10 according to the definition of the present invention. Shape, cross-section and contour of the hollow fibres or fibres respectively (13/14) as well as the kind of connection of the fibres/hollow fibres within the textile, fabric, texture, mesh etc. are not indicated in these representations. Moreover, for simplification sake, the area-measured material 10 is shown on these schematic representations with very regular structure only, what in reality is not necessarily the case, as the descriptions of the embodiments have revealed above. In these schematic representations quasi the projected shadow respectively of the sheet material 10 according to the present invention is shown. Since the outer diameter of the fibres/hollow fibres (tubes) can vary with their perimeter as well, the individual position of the fibres in the sheet has an influence on the projected shadow. This has been neglected in the regular schematic representations of FIGS. 7a to 7c. When calculating the percentage of perforations (voids) 12 the average outer diameter of the fibres/hollow fibres (tubes) is taken.

In the example according to FIG. 7a the percentage of perforations 12 related to the total spread surface area of the sheet material 10 amounts to about 25% and therefore is located in the lower limit range of the present invention. Thus the percentage of continuous surface consisting of fibres/hollow fibres (tubes) 14/13 is still relatively high.

In the example according to FIG. 7b the percentage of perforations (voids) 12 related to the total spread surface area of the sheet material 10 is considerably higher and amounts to about 53%. Accordingly, the percentage of fibres and hollow fibres (tubes) here is lower and amounts to only approximately less than half.
In the example according to FIG. 7c the percentage of perforations (voids) 12 related to the total spread surface area of the sheet material 10 is about 79% and therefore is still considerably higher than in the two embodiments described before. The percentage of fibres and hollow fibres (tubes) here only amounts to about one fifth of the sheet material. The fluid medium flows in the hollow fibres (tubes) only. Thus an exchange of energy with the environment takes place there only. Related to the total surface area of the sheet material 10 the effective surface for exchange of energy can be kept comparatively small as demonstrated in the example of FIG. 7c.

### LIST OF REFERENCE NUMBERS

10 area-measured material, sheet material
   11 collector
   12 perforations (voids)
13 hollow fibres, tubes, capillaries
14 fibres
15 end portion of the hollow fibres
16 internal volume of the collector
17 lumen of the hollow fibre
21 hollow fibres, tubes, capillaries or fibres
22 hollow fibres, tubes, capillaries or fibres
23 hollow fibres, tubes, capillaries or fibres 424 first group of hollow fibres, tubes, capillaries or fibres
25 second group of hollow fibres, tubes, capillaries or fibres
26 third group of hollow fibres, tubes, capillaries or fibres

1. Area-measured material comprising a continuous surface portion and a void content of at least 25% or more in relation to the total area covered by the area-measured material,
whereby, the continuous surface portion consists partially or totally out of hollow structures as in tubes or capillaries, wherein these hollow structures, tubes or capillaries are docked to at least one collector permitting fluid matter to flow within.

2. Area-measured material according to claim 1, characterized in that it is a textile sheet material in form of an openwork fabric, lace, knitted fabric, braid, netting, mesh, texture or non-woven fabric, comprising hollow fibres, tubes or capillaries as hollow structure.

3. Area-measured material according to claim 2, characterized in that at least 50%, preferably up to 100% volume of the fibres of the fabric, lace, knitted fabric, braid, netting, mesh, texture or non-woven fabric are out of hollow fibres, tubes or capillaries.

4. Area-measured material according to claim 3, characterized in that up to 100% volume of the fibres of the fabric, lace, knitted fabric, braid, netting, mesh, texture or non-woven fabric are out of hollow fibres, tubes or capillaries.

5. Area-measured material according to claim 1, characterized in that it comes in form of a sheet, film, panel, plate, or a composite of films or panels comprising the hollow structure, tubes or capillaries.

6. Area-measured material according to claim 1, characterized in that it comes in form of a structure of hollow and solid (massive) elongated grid elements comprising of ribbons which are interconnected by pins.

7. Area-measured material according to claim 1, characterized in that, the fluid medium transported in the hollow structures, tubes or capillaries is suitable to absorb and/or store and/or transport and/or emit energy.

8. Area-measured material according to claim 7, characterized in that the fluid medium transported in the hollow structures is suitable to absorb and/or store and/or transport and/or emit energy in the form of electro-magnetic waves.

9. Area-measured material according to claim 7, characterized in that it is suitable to convert the absorbed energy from one kind of energy or energy state into another kind of energy or energy state.

10. Area-measured material according to claim 7, characterized in that it comprises a device which is capable to convert the energy absorbed in the form of electro-magnetic waves into electricity, light or heat or it is connected to such a device as such.

11. Area-measured material according to claim 7, characterized in that it comprises a device suitable to absorb chemical energy, thermo-energy or mechanical energy and to convert it into electricity or it is connected to such a device.

12. Area-measured material according to claim 1, characterized in that said hollow structures, hollow fibres, tubes or capillaries comprise one lumen or several lumina.

13. Area-measured material according to claim 1, characterized in that it comprises of elongated hollow structures, hollow fibres, tubes, capillaries, pipes or hollow ribbons of any shape and any cross-section.

14. Area-measured material according to claim 1, characterized in that the hollow fibres, tubes, capillaries, hollow ribbons or hollow structures have an average inner diameter of at least about 1 mm.

15. Area-measured material according to claim 1, characterized in that the hollow fibres or hollow structures have a wall thickness of at least about 0.1 mm.

16. Area-measured material according to claim 2, characterized in that the hollow fibres, tubes or capillaries are mono-filaments.

17. Area-measured material according to claim 1, characterized in that the void content is 50% or more.
